(19) United States
(12) Patent Application Publication
(10) Pub. No.: US 2007/0231550 A1
(43) Pub. Date: Oct. 4, 2007

(54) Multi-layer laminates with film embossed on one side, base on partially acetalized polyvinyl alcohol

(75) Inventor: Holger Stenzel, Hennef (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: KURARAY Europe GmbH

(21) Appl. No.: 11/730,502

(22) Filed: Apr. 2, 2007

(30) Foreign Application Priority Data
Apr. 3, 2006 (EP) 06112159

(51) Int. Cl. B32B 3/00

(52) U.S. Cl. 428/172

(57) ABSTRACT

The invention relates to an embossing process for the production of a film based on partially acetalized polyvinyl alcohol. The film is embossed on one side with a roughnesses, R_{z}, of 20 to 80 sum by embossing the side of the film between correspondingly roughened embossing rollers and pressing rollers with a certain Shore A hardness. The temperature of the film and the rollers is adjusted in order to fix the structure.

The invention relates to a process for the production of a film based on partially acetalized polyvinyl alcohol with a smooth side and a roughness of the other side set by embossing and to the use of the films for the production of multi-layer laminates.

Standard composite glass panes consist of a glass/polyvinyl butyral (PVB)/glass laminate and have been used in the architectural sector or as a windscreen for motor vehicles for some considerable time. To improve the reflection and radiation absorption properties of this composite glazing, it is possible to use a laminate of two PVB films and an operating layer placed in between, instead of a single PVB film, e.g., according to WO 97/03763. The adhesion of the intermediate layer film to the glass is determined also in this case by the well known high adhesion properties of PVB, the additional function (e.g., reflection) being undertaken by the operating layer (e.g., PET film with a vapor deposited metal layer).

The PVB films used in such laminates must have different surfaces on the two sides of the film. The sides facing the glass must have a certain roughness or structure in order to allow a laminating process free from blisters and turbidity. The sides facing the operating layer, on the other hand, must be as smooth as possible.

A number of processes are known for the production of PBV films of a certain roughness or surface structure.

### STATE OF THE ART

A typical process for the production of films with a roughened surface is known from EP 0 185 863 B1 as the melt fracture process. Melt fracture processes lead to irregularly (stochastically) roughened surfaces.

Embossing processes are further processes described in the state of the art for the production of a roughened surface of intermediate layer films. The common feature of all film surfaces produced by embossing processes is a regular (non-stochastic) surface structure which exhibits a good ventilation behavior particularly in the production process for glass laminates by the vacuum bag process and consequently permits short process times and wide processing windows.

EP 0 741 640 B1 describes such an embossing process for the production of a surface embossed on both sides by means of two embossing rollers by means of which the film is provided with a regular line structure of the saw tooth type. The lines embossed on each side of the film cross each other at an angle of >25° such that a so-called moiré pattern is prevented from forming in the composite glass,

EP 1 233 007 A1 discloses an embossing process for avoiding the moire effect which process produces a regular liniform embossing structure on each side of the film. To avoid interferences, the line structures of the two film sides have different repetition frequencies.

Another process which is described in U.S. Pat. No. 5,972,280 uses only one roller to emboss the surface structure, instead of two embossing rollers, and a structured steel band fitting snugly to the roller via rolls and compressed air, the film being guided during the embossing process through the gap between the embossing roller and the steel band.

U.S. Pat. No. 4,671,913 discloses a process for embossing PVB films, the film being embossed in a single operating process between two structured rollers. The rollers—and consequently also the embossed film—have a roughness R_{z} of 10 to 60 μm.

The embossing processes on both sides described above have the disadvantage that only a short residence time of the film can be achieved in the roller gap. As a result, the embossing effect decreases considerably with an increasing embossing speed which is undesirable for an industrial production process. Moreover, films embossed on both sides are not suited to laminating with a further intermediate film layer, e.g., an operating film according to WO 97/03763 since the embossing structure is imprinted onto the operating film.

In an embossing process for only one side of the film, this effect does not occur and/or it is possible to to suppress it by appropriately selecting the roller surfaces and the embossing pressure. Thus, US 2003/0022015, WO 01/72509, U.S. Pat. No. 6,077,374 and U.S. Pat. No. 6,093,471 describe a one-stage and two-stage embossing process for PVB films using embossing rollers of steel and pressing rollers with a rubber coating. The rubber coating and/or the force applied between the rollers onto the film is not described in any further detail. If the roller surfaces are too hard, this leads to a small embossing zone which, in practice, is reduced to one line. This leads to a lower residence time of the film in the embossing zone and consequently to a lower embossing speed. If, on the other hand, roller surfaces are used which are too soft, only an insufficient force can be applied onto the film such that the embossing quality decreases.

The existing processes merit improvement with respect to the embossing performance.

### SUMMARY OF THE INVENTION

Thus, an aspect of the present invention is to develop a process for one-sidedly embossing films based on partially acetalized polyvinyl alcohol, which process does not exhibit the above-mentioned disadvantages.

Upon further study of the specification and appended claims, further objects, aspects and advantages of this invention will become apparent to those skilled in the art.

Surprisingly enough, it has been found that embossing of a film based on partially acetalized polyvinyl alcohol of sufficient quality and with a sufficient speed between an embossing roller and a pressing roller of a certain Shore A hardness is possible.

Thus, the present invention includes a process for the production of a film based on partially acetalized polyvinyl alcohol with a roughness of the first side of R_{z}=about 1 to 30 μm and a roughness of the second side of R_{z}=about 20 to 100 μm by the process steps of
a. providing the film based on partially acetalized polyvinyl alcohol with a roughness on both the first side and the second side of R_{z}=about 1 to 30 μm and
b. embossing the second side of the film between a correspondingly roughened embossing roller at a temperature of 80 to 170° C. and a pressing roller at a temperature of 0 to 60° C. to obtain a film with a roughness of the embossed surface of R_{z}=about 20 to 100 μm, the pressing roller having a Shore A hardness of about 50-80.

The entire disclosures of all applications, patents and publications, cited herein and of corresponding European application No. 06112159, filed Apr. 3, 2006, are incorporated by reference herein.

### BRIEF DESCRIPTION OF THE DRAWINGS

Various other features and attendant advantages of the present invention will be more fully appreciated as the same becomes better understood when considered in conjunction with the accompanying drawing wherein:

FIG. 1 illustrates the surface of the embossing zone between the embossing roller and the pressing roller;

FIG. 2 illustrates an embodiment according to the invention; and

FIG. 3 illustrates another embodiment according to the invention.

### DETAILED DESCRIPTION

Preferably, the process according to the invention leads to a non-stochastic roughness of the embossed side of the film.

Measuring the surface roughness of the film with the roughness value R_{Z} is effected according to DIN EN ISO 4287 and DIN ISO 4288. The measuring devices used to measure the surface roughness must satisfy EN ISO 3274. The profile filters used must correspond to DIN EN ISO 11562.

The surface structure and/or roughness of the film according to step a) may be applied, e.g., by the so-called flow or melt fracture process corresponding to EP 0 185 863 B1, the disclosure of which is hereby incorporated by reference. Different roughness levels can be produced by varying the width of the discharge gap and the temperature of the die lips directly on the die exit.

It is also possible to produce films by extrusion without melt fracture. Alternatively, the film can be produced by extrusion and smoothing over chilled rollers in line with U.S. Pat. No. 4,671,913, the disclosure of which is hereby incorporated by reference. The use of the films with as low a roughness as possible on both sides is preferred according to the process of the invention since rough structures can be over-embossed only with a greater embossing effort. Moreover, the original roughness may readjust itself during the production of the pre-composite such that the advantages of an embossed film compared with a surface roughened by melt fracture are reduced.

In the subsequent embossing process according to step b), the film is provided on one side with a surface structure with a roughness depth of R_{z}=20 to 100 μm, preferably R_{z}=about 20 to 80 μm, in particular R_{z}=about 30 μm to 50 μm.

The other, non-embossed side of the film preferably exhibits a roughness depth of R_{z}=1 to 30, preferably R_{z}=about 1 to 20, in particular R_{z}=about 1 to 10. This roughness may be identical to the roughness of the film according to step a) but can also be influenced in the embossing process according to b). By using appropriate pressing rollers, it is thus possible to reduce or increase the original roughness.

Before and/or after the embossing process b), the film can be cooled to about −10 to +20° C. to fix the surface structure of the film in this way. Cooling preferably takes place via correspondingly temperature-adjusted cooling rollers. In this case, so-called front cooling is possible, i.e., the embossed side of the film is cooled. An alternative is so-called back cooling in the case of which the non-embossed side of the film is cooled.

Cooling of the films may be restricted to their surface. Thus, the surface temperature of the side of the film to be embossed is adjusted to about −10 to +20° C. Alternatively, the non-embossed surface of the film can be adjusted to this temperature.

Preferably, the embossing rollers are made of metal and posses a surface with a negative profile pattern of the structure present later on in the film surface. The embossing rollers used according to the process of the invention must have a roughness corresponding to the intended roughness of the film. In a process variation, the embossed film and the embossing rollers have the same or almost the same roughness. Depending on the process parameters of film temperature, line pressure, roller temperature, roller speed or film speed, the roughness of the embossed film may also be considerably lower than that of the embossing rollers. Thus, the roughness R_{z} of the embossing rollers may be about 400%, preferably about 300%, in particular about 100% above the roughness R_{z} of the film surfaces embossed with this roller. The temperature of the embossing rollers is about 80 to 170° C., preferably about 100 to 150° C. and in particular about 110 to 140° C. Particularly preferably, the embossing rollers have a coated steel surface (e.g. PTFE) in order to reduce the adhesion of the film.

In the process according to the invention, the film is guided between the embossing roller and the pressing roller rotating in the opposite sense. Preferably, the film is exposed, between the embossing roller and the pressing roller, to a line pressure of about 20 to 80 N/mm, in particular about 40 to 65 N/mm. Line pressure should be understood to mean the pressing force of the roller pair based on the film width.

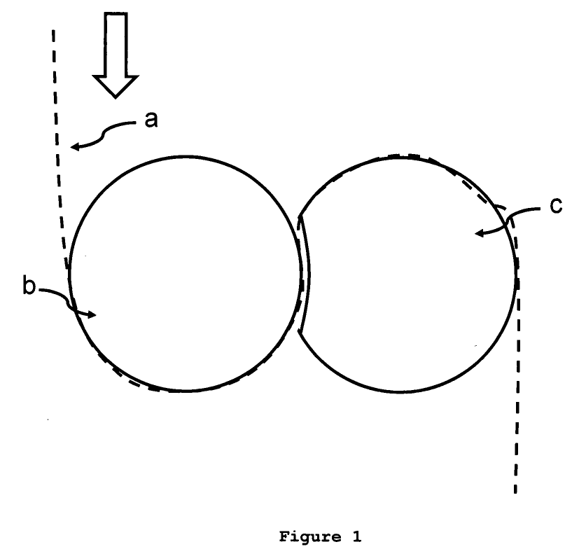

The pressing roller has temperatures of about 0 to 60° C., preferably about 10 to 40° C., i.e., it is actively cooled vis-à-vis the embossing roller. The pressing roller has no or only a slight roughness (R_{z} maximum 10 μm) and it preferably consists of a metal core with a surface of rubber or EPDM (ethylene-propylene diene elastomer). The surface of the pressing roller, in particular, has a Shore A hardness of about 60 to 75. The pressing roller presses the film into the structured surface of the embossing roller and nestles lightly against the embossing roller. By changing the line pressure, the surface of the embossing zone and consequently the residence time can be altered. This is illustrated diagrammatically in FIG. 1, a) indicating the film to be embossed, b) the embossing roller and c) the pressing roller. Apart from the film being guided around the rollers, shown here, a simple manner of guiding the film through the roller gap without passing around the roller is possible.

By selecting the process parameters of line pressure, film temperature and/or roller temperature, roller speed and enveloping angle of the film web on the rollers, the roughness depth of the film embossing can be influenced with a given roughness depth of the embossing roller.

The quality of the embossing process depends also on the constancy of the temperature of the film and consequently the chill, pressing and embossing rollers. Preferably, the temperature difference between the embossing and/or pressing rollers is consequently adjusted, over their width and circumference, to less than 2° C., in particular less than 1° C.

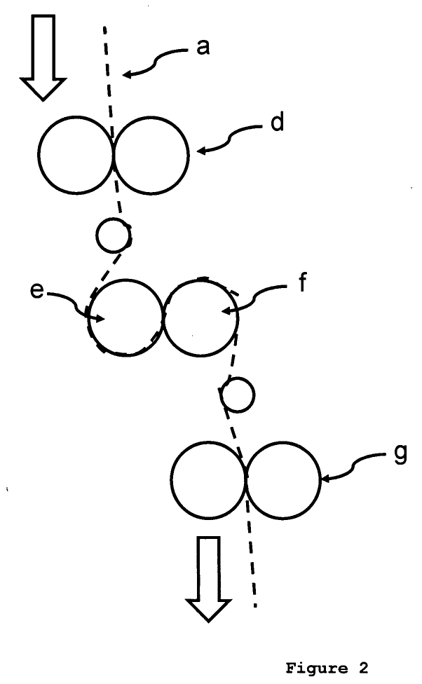

FIG. 2 shows diagrammatically a variation of the process according to the invention. The direction of travel of the film is indicated by double arrows. The film (a) which has been provided with a low roughness is optionally temperature-adjusted in the roller pair (d) and embossed on one side between the embossing roller (e) and the pressing roller (f). Rollers (e) and (f) are temperature-adjusted as described. Subsequently, the temperature of the film thus embossed on one side is adjusted in the roller pair (g) and consequently the embossed pattern is fixed. The rollers not provided with a reference in FIG. 2 are used to guide the film. For a better temperature adjustment, the roller pairs (d) and (g) can also be surrounded by the film such that the residence time of the film on the roller is increased.

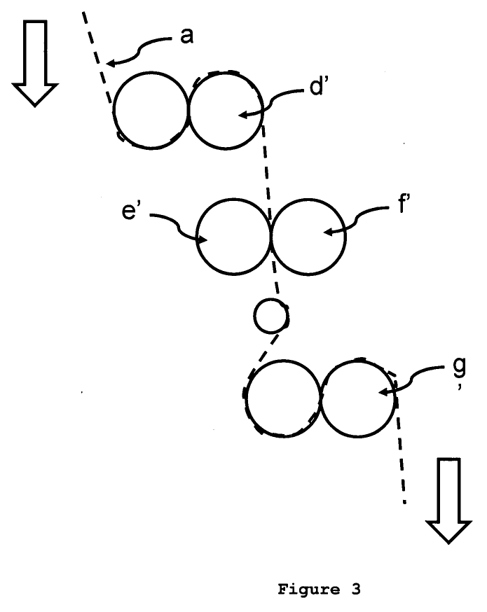

Alternatively, it is also possible to directly guide the film through the embossing gap without enveloping the embossing or pressing rollers. This variation of the process according to the invention is illustrated in FIG. 3. In this case, d′ and g′ represent roller pairs for temperature-adjustment of the film and e′ and f′ for pressing and/or embossing rollers. The use of the first pair of rollers do for temperature-adjustment of the film before embossing is optional.

In this case, too, the film can be guided through the roller gap of the temperature-adjustment rollers directly, i.e., without passing around them.

It is possible to use in particular polyvinyl butyral (PVB), in the crosslinked or non-crosslinked form as partially acetalized polyvinyl alcohol, in mixture with at least one plasticiser, dyes, pigments, metal salts for adhesion regulation, organic additives and/or inorganic fillers.

All plasticisers known in the art for this purpose, in particular the esters of multivalent acids, polyhydric alcohols or oligoether glycols, such as, e.g., adipic acid esters, sebacic acid esters or phthalic acid esters, in particular di-n-hexyl adipate, dibutyl sebacate, dioctyl phthalate, esters of diglycol, triglycol or tetraglycol with linear or branched aliphatic carboxylic acids and mixtures of these esters are suitable, on the one hand, as plasticisers for the partially acetalized polyvinyl alcohols. Esters of aliphatic diols with long chain aliphatic carboxylic acids, in particular esters of triethylene glycol with aliphatic carboxylic acids containing 6 to 10 C atoms, such as 2-ethyl butyric acid or n-heptanoic acid are preferably used as standard plasticisers for partially acetalized polyvinyl alcohols, in particular polyvinyl butyral. One or several plasticisers from the group consisting of di-n-hexyl adipate (DHA), dibutyl sebacate (DBS), dioctyl phthalate (DOP), esters of diglycol, triglycol or tetraglycol with linear or branched aliphatic carboxylic acids, in particular triethylene glycol-bis-2-ethyl butyrate (3GH), triethylene glycol-bis-n-heptanoate (3G7), triethylene glycol-bis-2-ethyl hexanoate (3G8), tetraethylene glycol-bis-n-heptanoate (4G7) are used particularly preferably.

In a particular embodiment of the present invention, the adhesion of the film to the embossing tools can be further reduced by adding one or more adhesion reducing substances to the film material. Generally, the total amount of adhesion reducing agents in the film material is about 0.0001-0.05 wt % (for example 0.01-2.0 wt %), preferably about 0.01-0.01 wt %.

For example, the adhesion reducing agents can be 0.01 to 2% by weight, based on the total mixture, of one or more pentaerythritol compounds according to formula I:

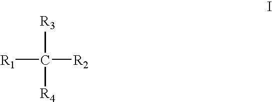

in which R₁, R₂, R₃, R₄ are each, identically or differently, CH₂OH, CH₂OR₅, CH₂OCOR₅ or CH₂OCO—R₆—COOR₅, and R₅ and R₆ are each, independently, saturated or unsaturated, branched, or unbranched hydrocarbon radicals with 1 to 26 carbon atoms.

In the case of the use of partially acetalized polyvinyl alcohols as polymeric materials, the pentaerythritols or their esters used as an optional additive facilitate also the use of special plasticisers which, for example, have an improved sound deadening effect on the films, compare also DE 199 38 159 A1, the entire disclosure of which is hereby incorporated by reference. The special plasticisers include in particular the group of plasticisers consisting of
polyalkylene glycols of the general formula HO—(R—O)ₙ—H with R=alkylene and n>5,
block copolymers of ethylene glycol and propylene glycol of the general formula HO—(CH₂—CH₂—O)ₙ—(CH₂—CH(CH₃) O)ₘ—H with n>2, m>3 and (n+m)<25,
derivatives of block copolymers of ethylene glycol and propylene glycol of the general formula R₁O—(CH₂—CH₂—O)ₙ—(CH₂—CH(CH₃)—O)ₘ—H and/or HO—(CH₂—CH₂—O)ₙ—(CH₂—CH(CH₃)—Oₘ—R₁ with n>2, m>3 and (n+m)<25 and R₁ as organic radical,
derivatives of polyalkylene glycols of the general formula R₁—O—(R₂—O)ₙ—H with R₂=alkylene and n≧2, in which the hydrogen of one of the two terminal hydroxy groups of the polyalkylene glycol is replaced by an organic radical R₁,
derivatives of polyalkylene glycols of the general formula R₁—O—(R₂—O)ₙ—R₃ with R₂=alkylene and n>5, in which the hydrogen of the two terminal hydroxy groups of the polyalkylene glycol is replaced by an organic radical R₁ or R₃.

In the case of partially acetalized polyvinyl alcohols, in particular PVB in this case, these special plasticisers are preferably used in combination with one or several standard plasticisers in a proportion of 0.1 to 15% by weight, based on the total mixture of plasticisers.

The plasticised partially acetalized polyvinyl alcohol resin preferably contains 25 to 45 parts by weight and preferably 30 to 40 parts by weight of plasticiser, based on 100 parts by weight of resin.

The partially acetalized polyvinyl alcohols are produced in the known way by acetylation of hydrolysed polyvinyl esters. Formaldehyde, acetaldehyde, propionaldehyde, butyraldehyde and such like, preferably butyraldehyde, for example, are used as aldehydes.

The preferred polyvinyl butyral resin contains 10 to 25% by weight, preferably 17 to 23% by weight and particularly preferably 19 to 21% by weight of vinyl alcohol radicals and/or 0 to 20% by weight, preferably 0.5 to 2.5% by weight of acetate radicals.

In a further process variation, a PVB partially crosslinked with a polyaldehyde (in particular glutaraldehyde) and an oxocarboxylic acid (in particular glyoxylic acid) is used as polymer according to WO 2004/063231 A1. Such a partially crosslinked PVB has a viscosity which is 10 to 50% higher than that of the analogous non-crosslinked PVB.

The water content of the films is preferably adjusted to 0.15 to 0.8% by weight, in particular to 0.3 to 0.5% by weight.

The films produced according to the invention can be used in particular for the manufacture of laminates from one or several polymer panes and at least one structured film produced according to the invention, the polymer film (operating film) being arranged between the non-embossed sides of the films produced according to the invention.

In the simplest case, such a laminate consists of five layers, namely glass/film/operating film/film/glass, the embossed sides of the films facing the glass and the non-embossed sides of the film facing the operating film.

Preferably, an optionally metal-coated polyethylene terephthalate film (PET) with a thickness of 10 to 100 μm is used as the operating film. Films of this type are known, e.g., from WO 97/03763. The laminates thus produced may be used as composite glazing in the architectural sector or as glazing for motor vehicles or aircraft.

During the manufacture of these laminates, a pre-composite is first produced from the glass/polymer panes and the film by pressing, vacuum bag or vacuum lip. As a rule, pre-composite laminates are slightly turbid as a result of air inclusions. The final manufacture of the laminate takes place in the autoclave, e.g., according to WO 03/033583.

### EXAMPLE

A plasticiser-containing PVB film of 72.5% by weight PVB, 25% by weight 3G8 with potassium salts and magnesium salts as antiblocking agents with a roughness on both sides of Rz≦5 μm is embossed in a facility according to FIG. 3.

Facility parameters:

| | |
|---|---|
| Embossing roller diameter: | 245 mm |
| Hardness of the rubber roller | 70 ± 5 Shore A |
| Diameter of the rubber roller: | 255 mm |
| Roughness of the embossing roller: | approximately 80 μm |
| Surface coating: | PTFE |

A film with the following embossing properties was obtained:

| | | T of | T of | | Rz (μm) |
|---|---|---|---|---|---|
| | Line | embossing | rubber | Rz (μm) | non- |
| Line speed | pressure | roller | roller | embossed | embossed |
| (m/min) | (N/mm) | (° C.) | (° C.) | side | side |
| 2.75 | 60 | 120 | 10 | 45 | <5 |

Two of the films thus obtained were placed together on the non-embossed side with a PET film of a thickness of 50 μm.

This film stack was subsequently placed between two glass panes and processed for 25 min at 95° C. in the vacuum cabinet at 200 mbar absolute to form an almost transparent pre-composite. This pre-composite was processed in an autoclave at 125° C., 12 bar for a period of 90 min to form a composite glass.

The preceding examples can be repeated with similar success by substituting the generically or specifically described reactants and/or operating conditions of this invention for those used in the preceding examples.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A process for the production of a film based on partially acetalized polyvinyl alcohol, said process comprising:
a. providing a film based on partially acetalized polyvinyl alcohol, wherein a first side of said file has a roughness, R_{z}, of 1 to 30 μm and a second side of said file has a roughness, R_{z}, of 1 to 30 μm, and
b. embossing said second side of the film between a correspondingly roughened embossing roller at a temperature of 80 to 170° C. and a pressing roller at a temperature of 0 to 60° C. to obtain a film with an embossed surface with a roughness, R_{z}, of 20 to 100 μm,
wherein said pressing roller has a Shore A hardness of 50-80.

2. A process according to claim 1, wherein film is exposed to a line pressure of 20 to 80 N/mm between said embossing roller and said pressing roller.

3. A process according to claim 1, wherein said pressing roller has a rubber or EPDM surface.

4. A process according to claim 1, wherein the temperature difference of the embossing roller is less than 2° C. across the width and the circumference of the roller.

5. A process according to claim 1, wherein the temperature difference of the pressing roller is less than 2° C. across the width and circumference of the roller.

6. A process according to claim 1, wherein the surface of the embossed side of the film has a roughness R_{z} of 20 to 80 μm.

7. A process according to claim 1, wherein the temperature of the film is adjusted to −10 0 to +20° C. before and/or after process step b).

8. A process according to claim 1, wherein the embossed side of the film is cooled.

9. A process according to claim 1, wherein the non-embossed side of the film is cooled.

10. A process according to claim 1, wherein the surface of the embossed side of the film has a roughness R_{z} of 30 to 50 μm.

11. A process according to claim 1, wherein each of the surfaces of the film provided in a) has a roughness, R_{z}, of 1 to 20 μm.

12. A process according to claim 1, wherein each of the surfaces of the film provided in a) has a roughness, R_{z}, of 1 to 10 μm.

13. A process according to claim 1, wherein the temperature of said embossing roller is 80 to 170°C.

14. A process according to claim 1, wherein the temperature of said embossing roller is 100 to 150° C.

15. A process according to claim 1, wherein the temperature of said embossing roller is 110 to 140° C.

16. A process according to claim 1, wherein said film is exposed to a line pressure of 40 to 65 N/mm between said embossing roller and said pressing roller.

17. A process according to claim 1, wherein the temperature of said pressing roller is 10 to 40° C.

18. A process according to claim 1, wherein said pressing roller has a Shore A hardness of 60 to 75.

19. A process according to claim 1, wherein said film contains at least one reducing adhesion substance to reduce the adhesion of the film to the embossing rollers.

20. A process according to claim 19, wherein said at least one reducing adhesion substance is a pentaerythritol compound according to formula I: 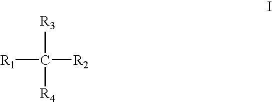
wherein
R₁, R₂, R₃, and R₄ are each, identically or differently, CH₂OH, CH₂OR₅, CH₂OCOR₅ or CH₂OCO—R₆—COOR₅, and
R₅ and R₆ are each, independently, saturated or unsaturated, branched, or unbranched hydrocarbon radicals with 1 to 26 carbon atoms.

20. A process according to claim 1, wherein said film based on partially acetalized polyvinyl alcohol is a film based on partially acetalized polyvinyl butyral.

21. A laminate comprising:
one or more polymer films and at least two embossed films produced according to the process of claim 1, said one or more polymer films being arranged between the non-embossed sides of said at least two embossed films.
